(19) United States
(12) Patent Application Publication
(10) Pub. No.: US 2018/0351712 A1
(43) Pub. Date: Dec. 6, 2018

(54) ASSIGNING METHOD OF PILOT SIGNALS AND BASE STATION USING THE SAME

(71) Applicant: NATIONAL CHUNG CHENG UNIVERSITY, CHIA-YI COUNTY (TW)

(72) Inventor: Wern-Ho SHEEN, CHIA-YI COUNTY (TW)

(21) Appl. No.: 15/645,510

(22) Filed: Jul. 10, 2017

(30) Foreign Application Priority Data
Jun. 2, 2017 (TW) 106118365

(51) Int. Cl. H04L 5/00; H04W 72/04; H04W 72/08; H04B 7/0452

(52) U.S. Cl. CPC H04L 5/0048; H04W 72/046; H04W 88/02; H04B 7/0452; H04W 72/082

(57) ABSTRACT

An assigning method of pilot signals and a base station are provided, which is adapted for the base station communicating with multiple user equipments (UEs) through multiple beams. The assigning method can be implemented by several algorithms, and the main steps of the assigning method are that processing signals on the beam domain, and determining whether one UE is interfered with others using the same pilot signal, to determine pilot signal of the UE. Accordingly, the computational speed for assigning pilot signals would be increased, and the error rate would remain low, without increasing pilot contamination.

### BACKGROUND OF THE DISCLOSURE

### 1. Field of the Disclosure

The present disclosure relates generally to Beam-group Division Multiple Access (BgDMA) communications, and more particularly, to an assigning method and a base station using the same.

### 2. Description of the Related Art

Industry and academia around the world have been focusing on the development of fifth-generation (5G) mobile communication system for many years. Among different technologies, the large-scale antenna technology is one of the most critical enablers for 5G system to achieve the performance requirements set forth by ITUR, where a base station can provide service to lots of users using the large-scale antenna at same time. However, there are some technical challenges facing the existing large-scale antenna technology: for example, (1) if performing signal processing per antenna-channel, lots of pilot signals would be needed for channel estimation, and the channel having high frequency selective characteristic may affect the system performance; (2) the complexity for high-order multiple user multiple input multiple output (MU-MIMO) may raise greatly.

Among lots of large-scale antenna technologies, Beam-group Division Multiple Access (BgDMA) system is proposed to solve the aforementioned problem. In BgDMA system, signal processing would be performed on the beam domain, so as to solve frequency selectivity, and the pilot signal density and the number of channel for estimation would be reduced greatly. It should be noticed that, a base station usually need to serve lots of users, and each user may need a certain bandwidth, thus the base station need to reuse the pilot signals. However, it is very complex to process signals on the spatial domain, and lots of information would be needed. Therefore, how to assign pilot signals to achieve low complexity and low interference becomes critically important issue for the related industries and researchers.

### SUMMARY OF THE DISCLOSURE

The present disclosure has been accomplished in view of the above-noted circumstances. It is an objective of the present disclosure to provide a user grouping method and a base station, which assign users having high interference to same group in low complexity way to mitigate interference, and further adjust oversized or undersized groups, so as to reduce complexity and improve system performance greatly.

To achieve the above objective, the present disclosure provides an assigning method, which can be adapted for a base station communicating with multiple user equipments (UEs) through multiple beams. The assigning method includes the following steps. Obtaining channel information of the UEs on each of the beams. Determining whether the beams used by the UEs are interfered with others according to the channel information. Determining pilot signals of the UEs according to interference determining result.

The present disclosure further provides a base station which communicates with multiple UEs through multiple beams. The base station includes a transmitting unit, a receiving unit and a processing unit. The transmitting unit is configured for transmitting data. The receiving unit is configured for receiving data. The processing unit is coupled to the transmitting unit and the receiving unit. The processing unit is configured at least but not limited for the following steps: Obtaining channel information of the UEs on each of the beams. Determining whether the beams used by the UEs are interfered with others according to the channel information. Determining pilot signals of the UEs according to interference determining result.

Compared with processing signal on spatial domain, the computational complexity of processing signal on beam domain is much lower, and the computational speed of that is also faster. In addition, on the basis of beam property, energy of all beam channels of UE almost belong to a few beam, thus a few contamination would remain on other beams, and those beams having less contamination can be assigned to other users for channel estimation.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a communication system according to a preferred embodiment of the present disclosure.

FIG. 2 is a block diagram of a base station according to the preferred embodiment of the present disclosure.

FIG. 3 is a block diagram of one of user equipments according to the preferred embodiment of the present disclosure.

FIG. 4 is a flow chart of a beam-set overlapping allocation method according to a first preferred embodiment of the present disclosure.

FIG. 5 is a flow chart of an inter-cell interference mitigation allocation method according to a second preferred embodiment of the present disclosure.

FIG. 6 is a flow chart of a maximum beam power based allocation method according to a third preferred embodiment of the present disclosure.

FIG. 7 is a flow chart of a less aggressive pilot reuse allocation method according to a fourth preferred embodiment of the present disclosure.

FIG. 8 is a flow chart of a less aggressive pilot reuse allocation method according to a fifth preferred embodiment of the present disclosure.

FIG. 9 is a flow chart of a random pilot allocation method according to a sixth preferred embodiment of the present disclosure.

FIG. 10 illustrates a beam set according to the sixth preferred embodiment of the present disclosure.

### DETAILED DESCRIPTION OF THE DISCLOSURE

Reference will now be made in detail to the present preferred embodiments of the disclosure, examples of which are illustrated in the accompanying drawings. Wherever possible, the same reference numbers are used in the drawings and the description to refer to the same or like parts.

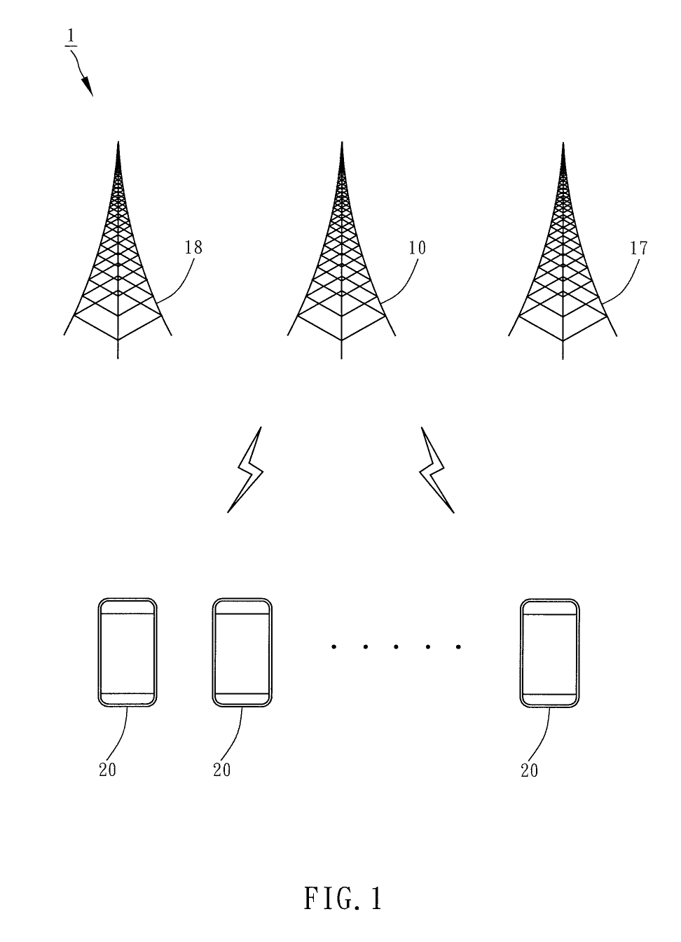

FIG. 1 illustrates a communication system 1 according to a preferred embodiment of the present disclosure. Referring to FIG. 1, the communication system 1 may include but not limited to three base station 10, 17, 18 and K user equipments (UEs) 20, where K is a positive integer. The communication system 1 belongs to a multiple user multiple input multiple output (MU-MIMO) communication system.

The term “base station” (BS) such as the BSs 10, 17, 18 in this disclosure could represent various embodiments which for example could include but not limited to a Home Evolved Node B (HeNB), an eNB, an advanced base station (ABS), a base transceiver system (BTS), an access point, a home base station, a relay station, a scatterer, a repeater, an intermediate node, an intermediary, and/or satellite-based communication base stations.

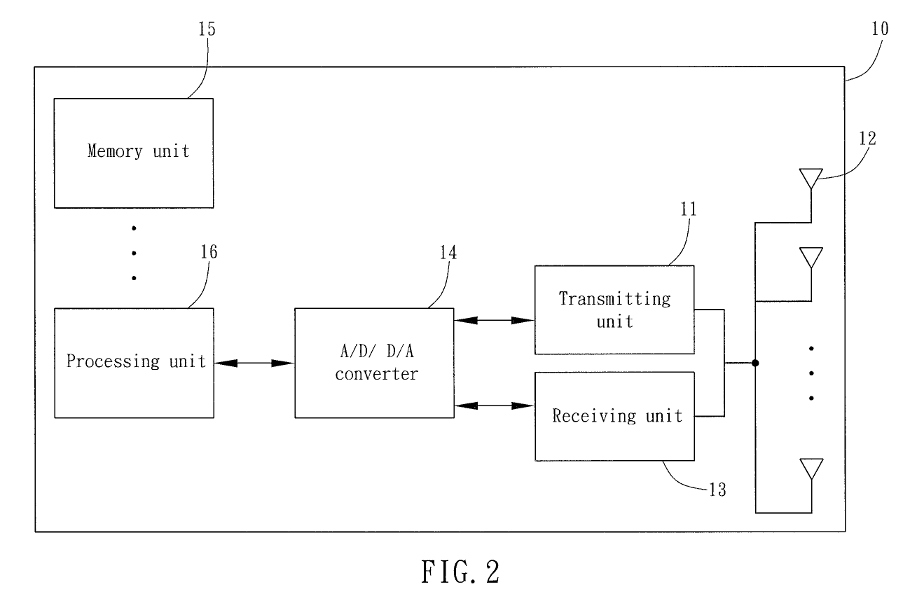

FIG. 2 is a block diagram of a base station 10 according to the preferred embodiment of the present disclosure., the BS 10 would include at least but not limited to a transmitting unit 11, multiple antennas 12, a receiving unit 13, an analog-to-digital (A/D)/digital-to-analog/(D/A) converter 14, a memory unit 15 and a processing unit 16. The transmitting unit 11 and the receiving unit 13 are used for transmitting and receiving modulated signals respectively, which could be wireless radio frequency (RF) signals through one or more antennas 12. The transmitting unit 11 and the receiving unit 13 may also perform operations such as low noise amplifying, impedance matching, frequency mixing, up or down frequency conversion, filtering, amplifying, and other related functions. The A/D and D/A converter 14 is configured to convert an analog signal format to a digital signal format during uplink communication and from a digital signal format to an analog signal format during downlink communication.

The processing unit 16 is configured to process digital signal and to perform a proposed method (for example, beam-domain processing, beam-finding and tracking, channel estimation, user grouping, pilot signal assignment/allocation, precoding and detection, etc.) described as follows in accordance with exemplary embodiments of the present disclosure. Also, the processing unit 16 may optionally be coupled to a non-transitory memory unit 15 (such as Erasable Programmable Read-Only Memory (EPROM), Electrically Erasable Programmable Read Only Memory (EEPROM) and cache memory, etc.) to store programming codes, configurations, buffering or permanent data, codebook, beambook, channel information (such as channel response, power gain, energy value, etc.), beam sets, and so forth. The functions of the processing unit 16 could be implemented by using programmable units such as a micro-processor, a micro-controller, a DSP chips, FPGA, etc. The functions of the processing unit 16 may also be implemented with separate electronic devices or ICs, and functions performed by the processing unit 16 may also be implemented within the domains of either hardware or software. In addition, different base stations 10, 17, 18 can transfer information to each other through inter base station transmission interface (not shown).

The term “user equipment” (UE) such as the UEs 20 in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, a mobile/portable communication device and so forth.

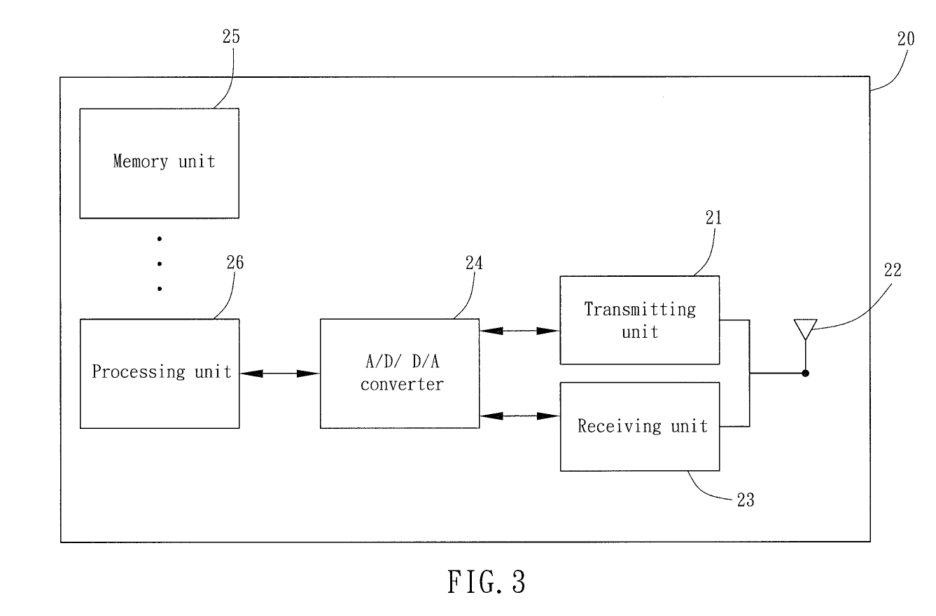

FIG. 3 is a block diagram of one of UEs 20 according to the preferred embodiment of the present disclosure. Each UE 20 may be represented by at least the functional elements as illustrated in FIG. 3 in accordance with an embodiment of the present disclosure. Each UE 20 would include at least but not limited to a transmitting unit 21, multiple antennas 22, a receiving unit 23, an analog-to-digital (A/D)/digital-to-analog/(D/A) converter 24, a memory unit 25 and a processing unit 26. The detailed description of functional elements of UE 20 may be referred to the description of functional elements of the BS 10 in FIG. 2, and therefore detailed descriptions for each element will not be repeated.

In the following description, the disclosure provides several algorithms for assigning pilot signals and adapted for the base station 10 of FIG. 2, and the assigning method of the disclosure would be introduced below with each unit of the base station 10. The steps of the method can be modified according to actual implementation, and the invention is not limited thereto.

In the communication system 1, the BS 10 can communicate with the UEs 20 through multiple beams, and the processing unit 16 can find the beams used by the UEs 20 (referred as detectable beams in the following) through the receiving unit 13 via the beam finding/tracking, and further obtain channel information (such as, energy value, power gain, etc.) of the UEs 20 on each beam. However, there are lots of detectable beams, so the processing unit 16 can select beams of the UEs 20 having loss of energy value less than a loss threshold η (such as, 0.05, 0.1, 0.15 dB, etc.) to form a beam set.

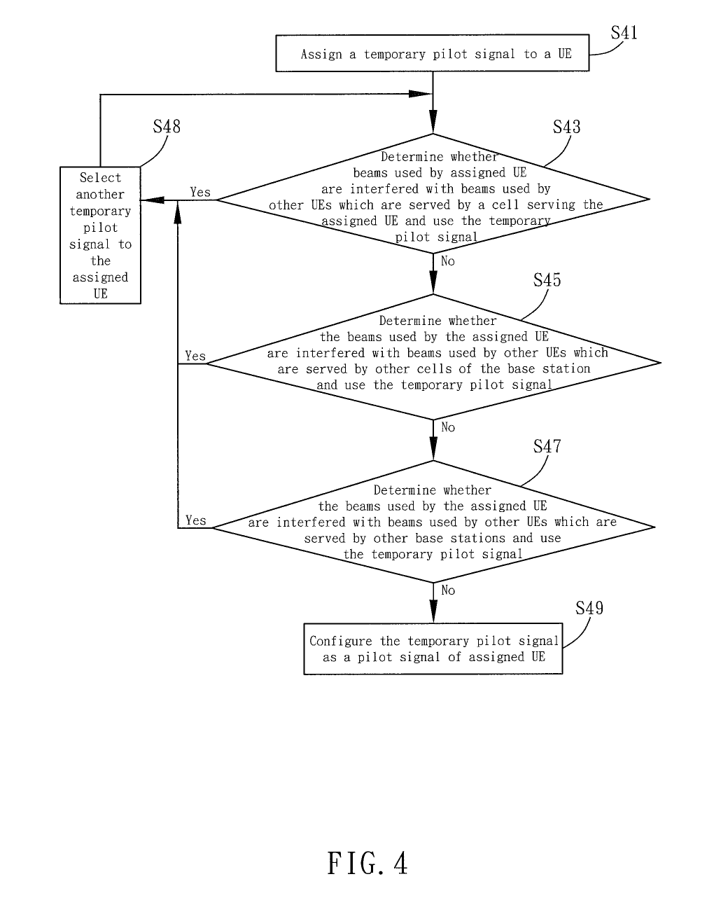

FIG. 4 is a flow chart of a beam-set overlapping allocation (BOLA) method according to a first preferred embodiment of the present disclosure. Because energy value of beam set of each UE 20 approximately equals to energy value of all beams, if the beam set of one UE 20 is not overlapped with others using the same pilot signal, the interference is low. On the basis of the concept, the processing unit 16 may assign a temporary pilot signal to one UE 20 (step S41), then whether beams used by the assigned UE 20 are interfered with others can be determined according to the channel information on the beams. The processing unit 16 determines whether beams used by assigned UE 20 are interfered with beams used by other UEs 20 which are served by a cell serving the assigned UE 20 and use the temporary pilot signal (step S43), i.e., determining whether the beam set of the assigned UE 20 is overlapped with different UEs 20 which are served by the cell serving the assigned UE 20 and use the same temporary pilot signal. If it is not interfered, the processing unit 16 determines whether the beams used by the assigned UE 20 are interfered with beams used by other UEs 20 which are served by other cells of the base station 10 and use the temporary pilot signal (step S45), i.e., determining whether the beam set of the assigned UE 20 is overlapped with different UEs 20 which are served by different cells and use the same temporary pilot signal. If it is not interfered, the processing unit 16 determines whether the beams used by the assigned UE 20 are interfered with beams used by other UEs 20 which are served by other base station 17 or 18 and use the temporary pilot signal (step S47). The processing unit 16 may determine pilot signals of the UEs 20 according to interference determining results of steps S41-S47. If any of the interference determining results is that the beams of the assigned UE 20 are interfered, the processing unit 16 would select another temporary pilot signal to the assigned UE 20 (step S48), and re-performs determination (back to step S43). If all of the interference determining results are that the beams of the assigned UE 20 are not interfered, the processing unit 16 may configure aforementioned temporary pilot signal as the pilot signal of corresponding U/E 20 (i.e. the assigned UE 20) (step S49), and select another temporary pilot signal to another UE 20 to determine (go to step S43) until all UEs 20 are assigned with pilot signals.

The fundamental concept of the aforementioned algorithm is that, beam sets of the UEs 20 using the same pilot signal are not overlapped, thereby reducing the interferences between those UEs 20 using the same pilot signal. Because energy value of the beam channels of each UE 20 in the beam set is almost the same as energy value of all beam channels, other beams, which are not selected into the beam set (i.e. loss of energy value of beam are larger than the loss threshold η), have small energy value and can be assigned to other UEs 20 for channel estimation, thereby reusing the same pilot signals in the same cell.

It should be noticed that, in the disclosure, the pilot signal for channel estimation may be orthogonal code (OC). Because different OCs are orthogonal between each other, using different OCs would not be interfered with each other. However, other coed can be adopted in other embodiments. In addition, it is assumed that the other base stations 17 and 18 belong to one cooperative base station set, and the cooperative base station set of each UE 20 includes base stations (such as base stations 17 and 18) providing signals having signal strength greater than a strength threshold while being received by the UE 20. However, the strength threshold may be modified according to actual requirement, so that the number of base station in the cooperative base station set may be also changed. On the other hand, in order to enable the description to be concise, in the following, the content of the same or similar steps would be omitted and can be referred to the description of FIG. 4.

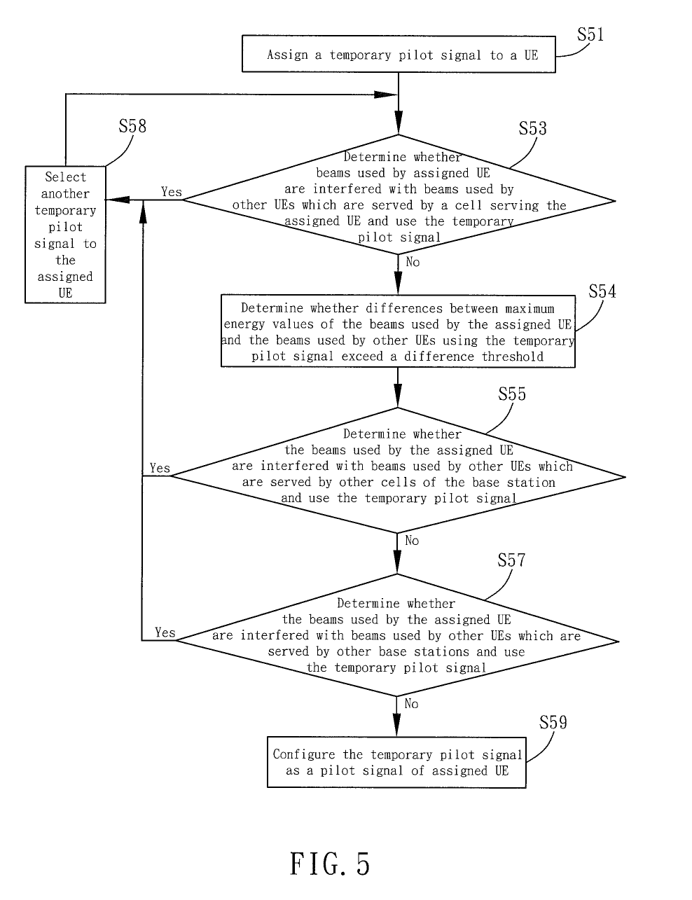

FIG. 5 is a flow chart of an inter-cell interference mitigation allocation (ICIMA) method according to a second preferred embodiment of the present disclosure. In order to improve the BOLA method of first preferred embodiment (for problem of interference between UEs 20 in one cell), in the second preferred embodiment, UEs 20 having larger difference of the strongest beam set may be assigned with different pilot signal. The differences between the first and second preferred embodiments are that, after determining whether beams used by assigned UE 20 are interfered with beams used by other UEs 20 which are served by a cell serving the assigned UE 20 and use the temporary pilot signal (step S53), if the beams of the assigned UE 20 are not interfered, the processing unit 16 may determine whether differences between maximum energy values of the beams used by the assigned UE 20 and the beams used by other UEs 20 using the temporary pilot signal exceed a difference threshold η (such as, 5, 10, 15 dB, etc.) (Step S54). If the differences does not exceed the difference threshold go to step S55. If the differences exceeds the difference threshold η, the processing unit 16 may assign another temporary pilot signal to the assigned UE 20 (step S58), and re-performs determination (back to step S53).

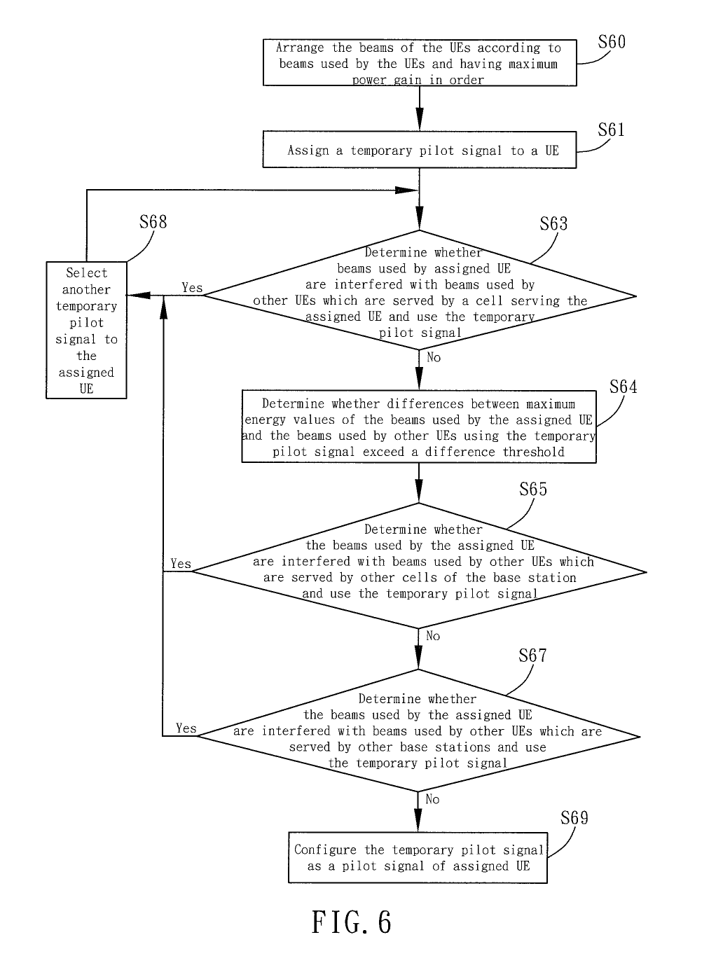

FIG. 6 is a flow chart of a maximum beam power based allocation (MBPBA) method according to a third preferred embodiment of the present disclosure. In this algorithm, when a UE 20 having lower power gain performs channel estimation, less other UEs 20 perform channel estimation at the same time. The differences between the second and third preferred embodiments are that, before the processing unit 16 assigns one temporary pilot signal to one UE 20 (step S61) through the transmitting unit 11, the processing unit 16 may arrange the beams of the UEs 20 according to beams of the UEs 20 having maximum power gain in order (step S60), i.e., arranging the UEs from the weakest to strongest power gain in order, and the processing unit 16 may perform the subsequent steps S61-S69 according to the arrangement. Therefore, when a UE 20 having weaker power gain performs channel estimation, the number of other UEs 20, which perform channel estimation at the same time, may be less than the UE 20 having stronger power gain.

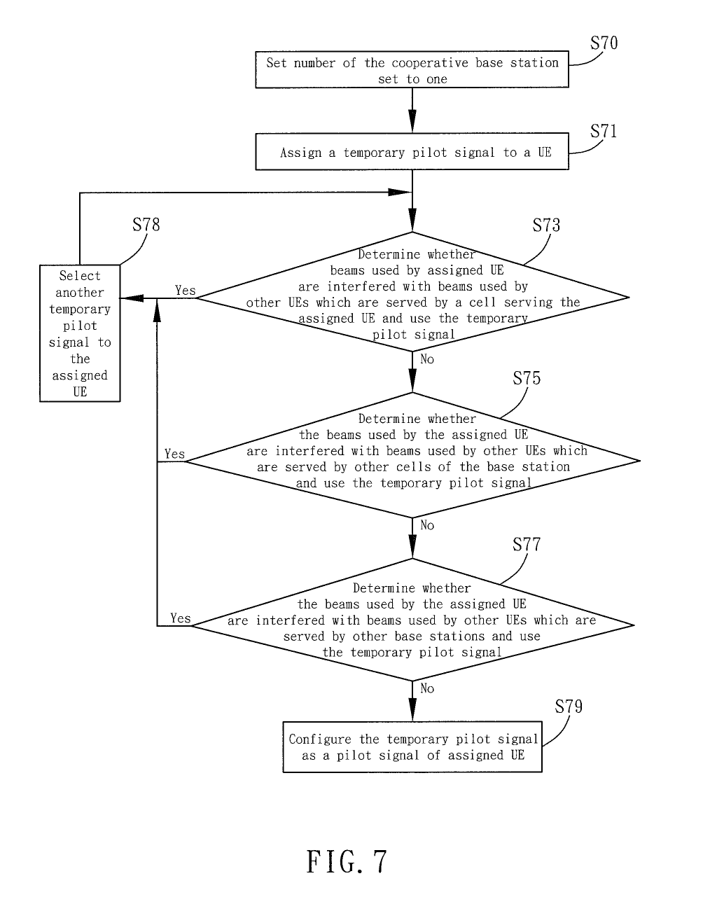

FIG. 7 is a flow chart of a less aggressive pilot reuse allocation (LAPRA) method according to a fourth preferred embodiment of the present disclosure, the method is combined with the first preferred embodiment. The differences between the first and fourth preferred embodiment are that, before the processing unit 16 assigns one temporary pilot signal to a UE 20 (step S71), the processing unit 16 may set number of the cooperative base station set to one (step S70) and combine with a mechanism that reuse factor is larger than one in code domain, thereby reducing interference between the UEs 20.

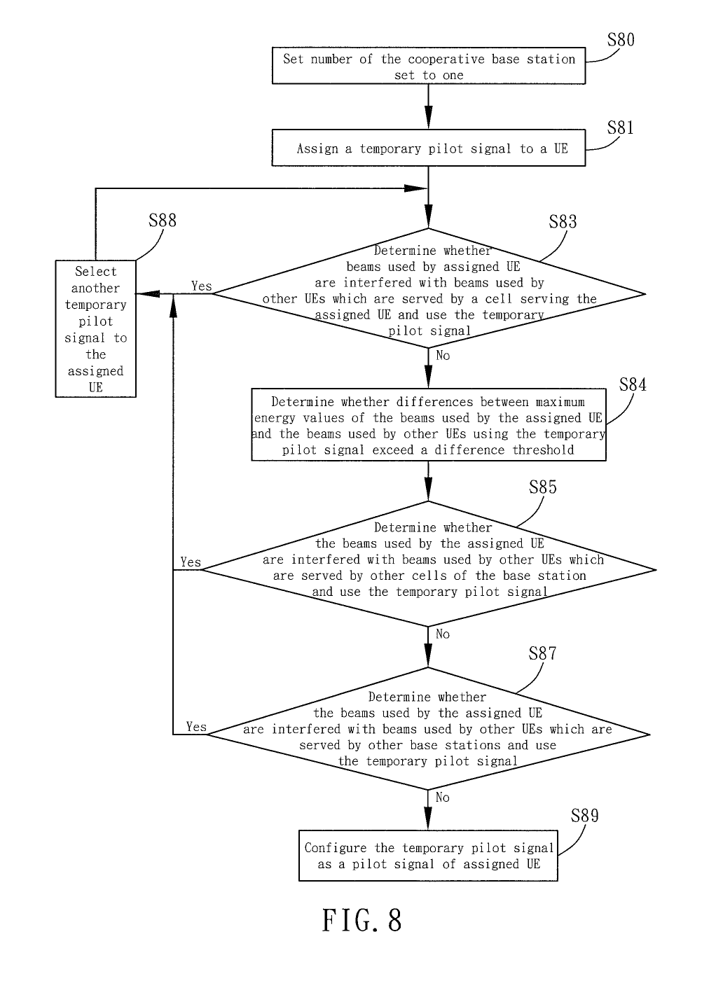

In addition, FIG. 8 is a flow chart of a LAPRA method according to a fifth preferred embodiment of the present disclosure, the method is combined with the second preferred embodiment. The differences between the second and fifth preferred embodiments are that, before the processing unit 16 assigns one temporary pilot signal to a UE 20 (step S81), the processing unit 16 may set number of the cooperative base station set to one (step S80) and combine with a mechanism that reuse factor is larger than one in code domain.

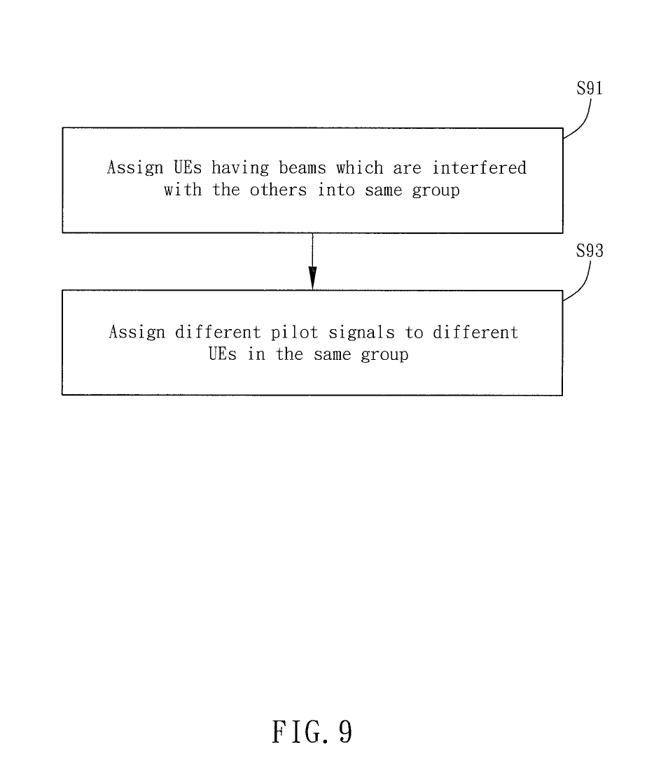

FIG. 9 is a flow chart of a random pilot allocation (RPA) method according to a sixth preferred embodiment of the present disclosure. After grouping the UEs 20 by user grouping method, because the beam sets of the UEs in each group are overlapped, thus the interference are very strong. After the base station 10 learns that beam information of UEs 20 in each group, the base station 10 can assign different pilot signals to the UEs 20 in each group at random. On the basis of the concept, when the processing unit 16 determines whether the selected beams used by the assigned UE 20 (having loss of energy value less than the loss threshold η) are interfered with others, the processing unit 16 may assign UEs 20 having beams which are interfered with the others into same group (step S91), i.e., the UEs 20 having beam set overlapped with others are grouped into the same group.

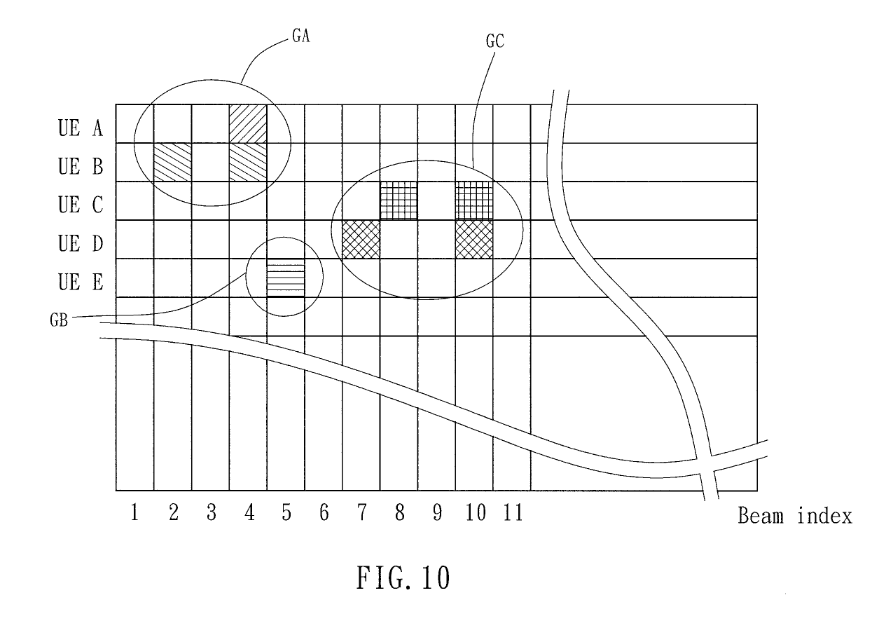

For example, FIG. 10 is an example of the user grouping method, FIG. 10 illustrates beam sets of UE A˜UE E. The beam of UE A having loss of energy value less than the loss threshold η is beam 4, and the beams of UE B having loss of energy value less than the loss threshold η are beams 2 and 4, then UEs A and B would be assigned into same group (GA), and so on for the others (GB and GC).

If the interference result is that the UEs 20 in the same group are interfered, the processing unit 16 may assign different pilot signals to different UEs 20 in the same group at random(step S93), to determine pilot signal of the UEs 20. For example, the processing unit 16 assigns different pilot signals to UE A and UE B in the group GA at random.

In conclusion, the proposed assigning method of the present disclosure utilizes beam domain property, and select beams having loss of energy value less than the loss threshold η to perform the interference determination, so that UEs using the same pilot signal (such as OC) would not interfered with each other. In other words, when the beams of different UEs are interfered with each other, these UE would be assigned with different pilot signal to avoid interference (different OC are orthogonal to each other). Compared with processing signal on the spatial domain, the embodiments of the disclosure can reduce the computational complexity effectively and increase the computational speed, and pilot contamination, redundant number and normalized square error can be improved.

The above description represents merely the preferred embodiment of the present disclosure, without any intention to limit the scope of the present disclosure. The simple variations and modifications not to be regarded as a departure from the spirit of the disclosure are intended to be included within the scope of the following claims.

What is claimed is:

1. An assigning method of pilot signals, adapted for a base station communicating with a plurality of user equipments (UEs) through a plurality of beams, the assigning method comprising:
obtaining channel information of the UEs on each of the beams;
determining whether the beams used by the UEs are interfered with others according to the channel information; and
determining pilot signals of the UEs according to interference determining result.

2. The assigning method as claimed in claim 1, wherein the channel information comprises energy value, and determining whether the beams used by the UE are interfered with the others comprises:
selecting beams used by each of the UEs and having loss of energy value less than a loss threshold; and
determining whether selected beams used by the UEs are interfered with the others.

3. The assigning method as claimed in claim 2, wherein determining whether selected beams used by the UEs are interfered with the others comprises:
assigning a temporary pilot signal to one of the UEs;
determining whether beams used by assigned UE are interfered with beams used by other UEs which are served by a cell serving the assigned UE and use the temporary pilot signal;
determining whether the beams used by the assigned UE are interfered with beams used by other UEs which are served by other cells of the base station and use the temporary pilot signal; and
determining whether the beams used by the assigned UE are interfered with beams used by other UEs which are served by other base stations and use the temporary pilot signal, wherein the other base stations belong to a cooperative base station set, and the cooperative base station set of each of the UEs comprises base stations providing signals having signal strength greater than a strength threshold while being received by the UE.

4. The assigning method as claimed in claim 3, after determining whether beams used by the assigned UE are interfered with beams used by other UEs which are served by the cell serving the assigned UE and use the temporary pilot signal, the assigning method further comprises:
determining whether differences between maximum energy values of the beams used by the assigned UE and the beams used by other UEs using the temporary pilot signal exceed a difference threshold.

5. The assigning method as claimed in claim 3, wherein the channel information comprises power gain, and before assigning a temporary pilot signal to one of the UEs, the assigning method further comprises:
arranging the beams of the UEs according to beams of the UEs having maximum power gain in order.

6. The assigning method as claimed in claim 3, wherein before assigning a temporary pilot signal to one of the UEs, the assigning method further comprises:
setting number of the cooperative base station set to one.

7. The assigning method as claimed in claim 3, wherein determining the pilot signals of the UEs according to the interference determining result comprises:
if the interference determining result is the beams are interfered, selecting another temporary pilot signal to re-determine; and
if the interference determining result is the beams are not interfered, configuring the temporary pilot signal as a pilot signal of corresponding UE.

8. The assigning method as claimed in claim 2, wherein determining whether the beams used by the UE are interfered with the others comprises:
assigning UEs having beams which are interfered with the others into same group.

9. The assigning method as claimed in claim 8, wherein determining the pilot signals of the UEs according to the interference determining result comprises:
assigning different pilot signals to different UEs in the same group.

10. A base station, communicating with a plurality of UEs through a plurality of beams, the base station comprising:
a transmitting unit, used for transmitting data;
a receiving unit, used for receiving data; and
a processing unit, coupled with the transmitting unit and the receiving unit, and the processing unit being configured for:
obtaining channel information of the UEs on each of the beams;
determining whether the beams used by the UEs are interfered with others according to the channel information; and
determining pilot signals of the UEs according to interference determining result.

11. The base station as claimed in claim 10, wherein the channel information comprises energy value, and the processing unit is configured for:
selecting beams used by each of the UEs and having loss of energy value less than a loss threshold; and
determining whether selected beams used by the UEs are interfered with the others.

12. The base station as claimed in claim 11, wherein the processing module is configured at least for:
assigning a temporary pilot signal to one of the UEs;
determining whether beams used by assigned UE are interfered with beams used by other UEs which are served by a cell serving the assigned UE and use the temporary pilot signal;
determining whether the beams used by the assigned UE are interfered with beams used by other UEs which are served by other cells of the base station and use the temporary pilot signal; and
determining whether the beams used by the assigned TIE are interfered with beams used by other UEs which are served by other base stations and use the temporary pilot signal, wherein the other base stations belong to a cooperative base station set, and the cooperative base station set of each of the UEs comprises base stations providing signals having signal strength greater than a strength threshold while being received by the UE.

13. The base station as claimed in claim 12, wherein the processing module is configured at least for:
determining whether differences between maximum energy values of the beams used by the assigned UE and the beams used by other UEs using the temporary pilot signal exceed a difference threshold.

14. The base station as claimed in claim 12, wherein the channel information comprises power gain, and the processing module is configured at least for:
arranging the beams of the UEs according to beams used by the UEs and having maximum power gain in order.

15. The base station as claimed in claim 12, wherein the processing module is configured at least for:
setting number of the cooperative base station set to one.

16. The base station as claimed in claim 14, wherein the processing module is configured at least for:
if the interference determining result is the beams are interfered, selecting another temporary pilot signal to re-determine; and
if the interference determining result is the beams are not interfered, configuring the temporary pilot signal as a pilot signal of corresponding UE.

17. The base station as claimed in claim 11, wherein the processing module is configured at least for:
assigning UEs having beams which are interfered with the others into same group.

18. The base station as claimed in claim 17, wherein the processing module is configured at least for:
assigning different pilot signals to different UEs in the same group.
